(19) United States
(12) Patent Application Publication
(10) Pub. No.: US 2013/0091925 A1
(43) Pub. Date: Apr. 18, 2013

(54) Method for Determining the Genetic Fingerpring of Hydrocarbons and Other Geological Fluids using Noble Gas Geochemistry

(71) Applicants: Thomas Henry Darrah, Durham, NC (US); Robert Joseph Poreda, Pittsford, NY (US)

(72) Inventors: Thomas Henry Darrah, Durham, NC (US); Robert Joseph Poreda, Pittsford, NY (US)

(21) Appl. No.: 13/651,060

(22) Filed: Oct. 12, 2012

Related U.S. Application Data
(60) Provisional application No. 61/546,497, filed on Oct. 12, 2011.

(51) Int. Cl. G01N 30/02; G01N 25/00

(52) U.S. Cl. 73/23.35; 73/23.2; 73/25.01

(57) ABSTRACT

Black shales differ from conventional gas plays in that in most cases there exists minimal geological scale gas migration. Thus, it is difficult to perform accurate reservoir characterization using classic geophysical and geological techniques (i.e. seismic analysis, gravity anomalies, structural geology, etc.). The principal technique that has traditionally been applied to determine the genetic history of gases or other fluids in the Earth's crust is the analysis of carbon isotopic composition of hydrocarbon gases and carbon dioxide, which has significant gaps in differentiating thermal and migrational histories. The present invention describes a method to determine the genetic fingerprint (i.e. identify the source formation and migration histories) of hydrocarbon gases or other crustal fluids of a geological system at lower cost and greater accuracy than existing methods (carbon and hydrogen isotopes) by analyzing the intrinsic, atmospheric and radiogenic (i.e. ⁴He, ²¹Ne*, and ⁴⁰Ar) noble gas composition of the fluids.

### CROSS-REFERENCE TO RELATED APPLICATIONS

This application claims the benefit of U.S. Provisional Application No. 61/546,497, filed Oct. 12, 2011, the entire contents of which is incorporated by reference herein.

### BACKGROUND

Organic-rich black shales are now major non-conventional natural gas reservoirs throughout North America and the world. For example, the Marcellus play extends from central New York to northern Tennessee within the Appalachian Basin. While these unconventional hydrocarbon reservoirs were long thought to be non-economically viable, they have recently come into play following advances in drilling (i.e. horizontal drilling) and extraction capabilities (i.e. hydraulic fracturing). Black shales differ from conventional gas plays in that in most cases there exists minimal geological scale gas migration (i.e. oil and gas are still found in the geological units in which they form; the source is the reservoir). Some potentially important consequences of this “source-reservoir” relationship that differ from conventional plays that must be accurately characterized in order to estimate the economic viability of unconventional plays include: total hydrocarbon potential (i.e. total organic content (TOC)), thermal history (which determines the type of hydrocarbon produced: oil, wet gas, mixed gas, dry gas), the amount of geological scale gas migration (i.e. expulsion from the reservoir, migration to potential structural traps, etc.), and the porosity and permeability of potential hydrocarbon producing units. Because black shales are nonconventional reservoirs, it is difficult to perform accurate reservoir characterization using classic geophysical and geological techniques (i.e. seismic analysis, gravity anomalies, structural geology, etc.).

There are currently significant gaps in the geochemical fingerprints capable of evaluating the genetic and migrational histories of both conventional and unconventional natural gases. The principal technique that has traditionally been applied to determine (i.e. “fingerprint”) the genetic history (source and migration) of gases or other fluids in the Earth's crust is the analysis of carbon isotopic composition of hydrocarbon gases and carbon dioxide. Within the context of petroleum geochemistry, a paradigm has been developed over the last 30+ years that classifies natural gases into one of two genetic groups, biogenic or thermogenic based on molecular ratios (e.g. wetness: C₂+/C₁ (typically 1-30%)) and isotopic composition (δ¹³Cx (‰). The composition of thermogenic gases result from inorganic and organic carbon reactions associated with thermal degradation of the organic source (i.e. kerogen or liquid hydrocarbons), which imprints diagnostic molecular (i.e. relative proportions of C₁, C₂, C₃, etc.) and isotopic (δ¹³C and δ²H of C₁, C₂, etc.) compositions on thermogenic hydrocarbon gas. By comparison, biogenic gas is generated at low temperature (<<100° C.) in anoxic conditions from the microbial decomposition of organic matter or reduction of CO₂. Microbes produce methane (C₁) gas almost exclusively (>>99%; C₂+/C₁≦1×10⁻⁴; i.e. C₁/C₂+>>1000)) with a typically light δ¹³C—C₁<−60 to −70‰ isotopic composition. In addition, to the multiple potential sources, hydrocarbon fluids can be altered after their formation by processes such as diffusive fractionation where migrating gases are enriched in ¹²C and ¹H. The potential significance of the latter interpretation has been minimized in light of more recent work that has drastically expanded our comprehension of the significance of subsurface microbial formation of natural gas and the degradation of oil and coal deposits by biological processes (e.g., aerobic and anaerobic degradation of hydrocarbons).

In comparison to hydrocarbon molecular and isotopic compositions, which record the history of organic and inorganic carbon reactions (whether driven by biological or thermocatalytic processes), the elemental and isotopic composition of noble gases (i.e. helium (He), neon (Ne), argon (Ar), krypton (Kr), xenon (Xe)) provide an inert geochemical tracer that is unaffected by chemical reactions or microbial activity. Instead these parameters record the source, migrational process, and residence time of crustal fluids. Noble gases can be used to define the physical conditions that affect geological systems including the source of fluid origins, fluid diffusion, permeability, temperature, and fluid flow. Noble gas geochemistry has been used to evaluate the source and degree of mixing between various geological fluids and the character of fluid migration mechanisms. The rate of diffusion for helium and other noble gases in minerals such as quartz is temperature dependent. At the temperature of thermogenic methane production, the ⁴He diffusion coefficient is six orders of magnitude greater than Ne or Ar. At lower temperatures of hydrocarbon formation there is a preferential release of the light noble gases (He, Ne) relative to the heavier gases (Ar, Kr), leading to extreme enrichment of the light noble gas components. At higher temperatures of hydrocarbon formation (CAI>3), the release of heavier noble gases increase (e.g. ⁴⁰Ar*) while light noble gas (He, Ne) release approaches 100%, thus the ratio of light to heavy noble gases approach the production ratios for the radiogenic/nucleogenic noble gases. Thus, in a simple, first order way the ⁴He/²¹Ne*, ⁴He/⁴⁰Ar* and ²¹Ne*/⁴⁰Ar* reflect temperature. The noble gas signatures that most clearly distinguish the genetic groups are ⁴He/⁴⁰Ar* and ²¹Ne*/⁴⁰Ar*, which significantly decrease with thermal maturity (similar to “normal” trends with carbon isotopes and C₁/C₂). Lower thermal maturity natural gases have higher ⁴He/⁴⁰Ar* and ²¹Ne*/⁴⁰Ar* (1.6-8)), whereas the more thermally mature gases have radiogenic/nucleogenic isotopes trending toward production ratios (low ²¹Ne*/⁴⁰Ar* (0.2-1.1)).

Paired analyses of noble gases and hydrocarbon composition often provide valuable insights into the source, migrational history, and residence time of crustal fluids. The inert behavior of the noble gases eliminates the need to make assumptions regarding the sources, original concentration, and/or isotopic compositions of C₁, C₂, C₂₊ hydrocarbons. Thus, noble gas geochemistry provides a unique, inert, and externally defined variable capable of distinguishing the genetic fingerprint of hydrocarbon fluids evaluating source, mixing, and migration within the Earth's crust. Specifically, the temperature dependent release of radiogenic noble gas components from the shale matrix allow for an estimation of prior thermal history for natural gases.

### SUMMARY

The present invention describes a method to determine the genetic fingerprint (i.e. identify the source formation and migration histories) of hydrocarbon gases or other crustal fluids of a geological system at lower cost and greater accuracy than existing methods by analyzing the intrinsic, atmospheric and radiogenic noble gas composition of the fluids. Atmospheric noble gases are incorporated into crustal fluids in approximately uniform initial compositions according to their fluids. By comparison, radiogenic noble gases are produced in-situ within the black shale matrix and their diffusion out of the crustal rock matrix is dependent on the thermocatalytic generation conditions of natural gas formation (i.e. temperature). As a result, they have significant potential for recording the genetic fingerprint or tracking hydrocarbon formation and migration. In a simple, first order way the ⁴He/²¹Ne*, ⁴He/⁴⁰Ar* and ²¹Ne*/⁴⁰Ar* serve as a proxy for temperature. In this framework, lower thermal maturity natural gases have higher ⁴He/⁴⁰Ar* and ²¹Ne*/⁴⁰Ar* (i.e. preferential release of ⁴He and ²¹Ne* with retention of ⁴⁰Ar*), whereas the more thermally mature (i.e. hotter) gases have radiogenic/nucleogenic isotopes trending toward production ratios (i.e. lower ⁴He/⁴⁰Ar* and ²¹Ne*/⁴⁰Ar*) (efficient release of larger ionic radius radiogenic components (i.e. ⁴⁰Ar*).

Noble gases also have the added benefit of being inert and thus unaltered by organic or inorganic chemical reactions during or after production. In addition, noble gases include a suite of elements with a range of diffusional rates (both in geological fluids and mineral grains) and solubilities. For example, Helium and Neon diffuse faster than methane and have lower solubilities in water, hydrocarbon fluids, or the quartz matrix. By comparison, methane and argon solubilities are identical, while their diffusion rates are comparable (Argon is slightly slower). The heavy noble gases strongly adsorb to the organic matter that sources oil and gas, and thus the release of these noble gas tracers into the hydrocarbon gas phase will mimic desorption of natural gas from unconventional lithologies (Xenon and Radon).

Additionally, because noble gases closely approximate the behavior of ideal gases (i.e. because they have a simpler equation of state at relevant reservoir pressures and temperatures and exceedingly low partial pressures that approach ideality), they do not require computationally intensive recalibration by equations for state, and thus have great potential for developing an integrated model of the porosity of a play over geological time and a forward model of gas behavior throughout the production process. These factors are critical in many unconventional shale plays, which are “over-pressured” (i.e. the gas pressure greatly exceeds 10-50% lithostatic and hydrostatic pressure), introducing significant calculations when re-calibrating by equations of state.

According to a first aspect of the invention, it is possible to differentiate/distinguish gases (i.e. gases from an exploration or production well or natural seeps) from two or more distinct source rocks or migrational histories by analyzing the noble gas geochemistry. Furthermore, these techniques can differentiate/distinguish gases that reside within specific host rocks. Of specific importance is the ability to monitor the release of radiogenic noble gases from the crustal reservoir rocks (i.e. a temperature dependent process). As the thermal maturity of organic-rich kerogen material increases (i.e. is heated or cooked by geological processes and undergoes catagenesis (the formation of ordered hydrocarbons: e.g. oil, methane, ethane, etc.), the noble gas composition changes in accordance with the temperature dependent release of radiogenic noble gases (⁴He,²¹Ne*, ⁴⁰Ar*) as calculated by the following:
a. excess ²¹Ne (²¹Ne*) using the atmospheric ratio of ²¹Ne/²²Ne (0.0289) according to the equation:

²¹Ne*={[(²¹Ne/²²Ne)_{measured}−0.0289]×²²Ne_{measured}} a.
b. a mantle or radiogenic component) using the atmospheric ratio of ⁴⁰Ar/³⁶ Ar (295.5) according to the equation:

⁴⁰Ar*={[(⁴⁰Ar/³⁶Ar)_{measured}−295.5]×[36Ar]measured} b.

According to a further aspect of the invention, one can differentiate naturally present gases in shallow aquifers from those released by anthropogenic activities (i.e. fugitive/stray gas). The techniques described herein can differentiate gases that have migrated from source rocks naturally from those released by industry activities into environment.

### DETAILED DESCRIPTION OF EMBODIMENTS

The noble gas composition of hydrocarbons and other geological fluids are derived from three primary sources including the mantle (M), atmosphere (A), and fluids derived within the crust (C) itself Atmospheric, mantle, and/or crustal components are characterized by unique noble gas elemental and isotopic signatures. The fluids that influence the noble gas composition of crustal fluids (including hydrocarbons) are a function of: 1) the source rock (unit(s) in which the fluids are generated); 2) the reservoir rock (host) (unit(s) in which fluids are stored or trapped); and/or 3) mixtures with other migrating fluids.

Atmospheric noble gases (AIR) are incorporated into crustal fluids either when water equilibrates with atmospheric gases prior to recharge into the subsurface (termed air saturated water (ASW)) or as sedimentation pore water entrained at the time of sediment deposition. The relevant concentrations of noble gases dissolved in groundwater are dependent upon temperature equilibrium at the time of recharge and the Henry's Law solubility of each noble gas, where the Henry's Law constant increases in the heavier noble gas (i.e. solubility: He<Ne<Ar<Kr<Xe). In comparison to crustal fluids, circulating fluids with ASW composition (i.e. groundwater or remnant pore water) typically have low [⁴He] (but higher ³He/⁴He (e.g. 1.36×10⁻⁶ or ˜0.985 Ra, where Ra=1.39×10⁻⁶), as compared to crustal generated noble gases, and elevated ²⁰Ne (175-220 μcc/kg) with atmospheric isotopic composition (²⁰Ne/²²Ne (9.8) and ²¹Ne/²²Ne (˜0.0289)). The majority of circulating groundwater has an anticipated range for [Ar] (0.28-49 cc/kg) with atmospheric ⁴⁰Ar/³⁶Ar (˜295.5) and ⁸⁴Kr (35-69 μcc/kg). The relevant isotopic composition of ASW has low solubility controlled ⁴He/²¹Ne (e.g. 85), ⁴He/²¹Ne*=0, ²⁰Ne/³⁶Ar (˜0.12-0.17) and ⁸⁴Kr/³⁶Ar (˜0.035-0.04). Thus, the amount of ASW-type gas in a natural gas deposit (e.g. ²⁰Ne, ³⁶Ar, or ⁸⁴Kr) provides a proxy for the total amount of a given fluid's interaction with water (i.e. circulating meteoric groundwater and/or remnant sedimentation water). We suggest that gas samples with dominantly ASW composition have witnessed extensive interaction with groundwater and in general tend to be in young, low U-Th settings. Because there are no relevant radiogenic and/or nucleogenic sources of ²⁰Ne, ³⁶Ar, and ⁸⁴Kr produced in the crust, their relevant isotopic ratios ²⁰Ne/³⁶Ar and ⁸⁴Kr/³⁶Ar should reflect a combination of ASW and/or migratory diffusion/gas-liquid phase separation.

In the crust, as the age of the sediment increases, the proportion of radiogenic gases relative to ASW increases. In order to utilize noble gas geochemistry to understand these processes, we must first consider the geochemical signature that the natural gas will acquire as it interacts with the fluids and rocks in the Earth's crust. As hydrocarbon or meteoritic fluids interact with crustal fluids, the most relevant changes in noble gas composition relate to the radiogenic nature and geologic history of the rock protolith through which fluids migrate. From the time of sediment deposition, the noble gas composition of natural gases, initially containing a mixture of dissolved atmospheric components, becomes increasingly enriched in ⁴He, ²¹Ne*, ⁴⁰Ar* derived from the lithospheric matrix over time. The composition of the evolved gas will depend on the crustal abundance of U, Th and K in the source (and/or later host) rocks, the degree of interaction between meteoric fluids or seawater and the source rock, and the age of the formation.

The known production rates of ⁴He and ²¹Ne from the radiogenic decay of uranium and thorium (both of which are present at relatively high concentrations in most black shales i.e. [U]˜1-30 ppm and [Th]˜1-25 ppm) and ⁴⁰Ar from ⁴⁰K (average of ˜26,000 ppm in UCC)) lead to the production of characteristic ratios of these radiogenic gases in crustal rocks, including black shales. In shale, ⁴He (an a particle), produced from the decay of U-Th (i.e. ^{(232 or 238)}U and ²³²Th→⁴He), travels ˜6 to 8 microns to either embed in a quartz (or other mineral) grain as a He atom or interacts with an ¹⁸O atom within the quartz to concurrently produce ²¹Ne* (i.e. nucleogenic ¹⁸O(α, n)). This concurrent production yields an average ⁴He/²¹Ne* of 22×10⁶ for Paleozoic crust. Thus, while the total concentration of [⁴He] or [²¹Ne*] depends on [U] and [Th], the ⁴He/²¹Ne* production ratio is actually independent of absolute U and Th concentrations and remains relatively constant in non-fractionated gases.

Following the production of noble gases within crustal minerals, the physico-chemical conditions and the diffusion constant of each gas will determine the interaction of gases with migrating fluids and their release from mineral grains. In addition, the retentivity of a given mineral phase is highly variable. For example, quartz is far more retentive than plagioclase, dolomite, or clay grains. The consistent production ratio, and predictable, mineral phase dependent, retentivity of these decay products (i.e. ⁴He, ²¹Ne*, ⁴⁰Ar*) make radiogenic noble gases useful for tracing fluid-rock interactions and thermal history, specifically in shale. This utility stems from the different manners in which each noble gas interacts with quartz crystals in quartz-rich shale. Helium is particularly relevant for evaluating these processes because it has a unique property in which it dissolves into (and out of) quartz and thus partitions between gas and solid according to helium solubility. Over millions of years, the helium in pore spaces is freely available to interact with and dissolve in circulating fluids and thus reaches equilibrium with the helium concentration in the quartz crystal. Conversely ²¹Ne (i.e. ²¹Ne*) formed and embedded within the quartz grain has a larger atomic radius and significantly lower diffusion in quartz (or other minerals) at relevant geological temperatures, but migrates to the pore space at higher temperature or as the result of quartz breakdown. Similarly, ⁴⁰Ar*, which is less diffusive than ²¹Ne* at a given temperature, remains behind unless temperatures are further increased beyond ˜200° C. Only ²¹Ne* or ⁴⁰Ar* that forms in non-retentive phases or whose carrier phase is subject to temperatures above the closure temperature will migrate to the gas/fluid phase.

Fluids with extensive water-rock interaction or migration, specifically at low temperatures, will experience an increase in the ⁴He/²¹Ne* (i.e. ²¹Ne* left behind). Lithologies with higher thermal histories will less efficiently retain the ²¹Ne* (or ⁴⁰Ar*) in the quartz grain (i.e. ⁴He/²¹Ne* approaching production). Therefore, measuring the ⁴He and ²¹Ne* concentrations and constructing a degassing/diffusion profile may identify areas where extensive fluid flow has occurred. When measured in natural gases, the ⁴He/²¹Ne* can provide an estimate of the volume of shale that has degassed, the extent of water-rock interaction, migration controlled diffusion of circulating crustal fluids, or provide a genetic fingerprint of fugitive gas “shows”.

The ⁴He/⁴⁰Ar* production ratio, is the most dependent on the relative concentrations of U and Th as compared to K (i.e. K/U or K/(U+Th)) within the source and host rock. As compared to the ⁴He/²¹Ne*, ⁴⁰Ar* from ⁴⁰K decay and the resulting ⁴He/⁴⁰Ar* or ²¹Ne*/⁴⁰Ar* may be highly variable because the K/U in black shales is not constant or of typical crustal composition, but instead is altered by the enrichment of U in reducing black shales. For example, in typical black shales such as the Marcellus shale, K/U ratio ranges to as low as ˜1,800-2,200 because of the accumulation of U with organic matter. For the average crustal composition (K/U ratio of 12,000, the current production ratio of ⁴He/⁴⁰Ar* is ˜6-9. The low K/U ratios observed in organic-rich black shales may result in an estimated ⁴He/⁴⁰Ar* production ratio as high as ˜15-17. As a result, the ⁴He/⁴⁰Ar* can be strongly impacted by the relative K/(U+Th) ratio of the source and host rock (directly providing a source rock fingerprint, as well as the disparate, temperature dependent rates of helium and argon diffusion. By knowing the initial K/(U+Th) in a sequence of given formations (typically available by core logging, gamma logging, cuttings, etc). One can calculate the anticipated distributions of ⁴He, ²¹Ne*, and ⁴⁰Ar*. Given an initial starting composition, one can then model the releases of these gases according to temperature, providing a unique ability to determine the fingerprint of a gas independent of the initial conditions.

What is claimed is:

1. A method comprising determining the lithological origin of a subject gas sampled from a source location.

2. The method of claim 1, further comprising analyzing migration characteristics of the subject gas using noble gas geochemistry.

3. The method of claim 2, wherein analyzing migration characteristics includes evaluating temperature-dependent diffusional release of noble gases from quartz grains at the source location, chromatographic separation/solubility fractionation during fluid migration, and degree of water interaction with rock at the source location.

4. The method of claim 2, wherein analyzing migration characteristics includes determining a noble gas composition of the subject gas and comparing the noble gas composition with a corresponding noble gas composition of a reference gas sampled from the source location and applying a linear discriminant statistical analysis.

5. The method of claim 2, wherein analyzing migration characteristics further comprises determining a noble gas composition of the subject gas and comparing the noble gas composition with a corresponding noble gas composition of a reference gas sampled from the source location and applying statistical analysis.

6. The method of claim 2, wherein the subject gas is a hydrocarbon.

7. The method of claim 6, wherein the subject gas is a thermally-mature hydrocarbon.

8. The method of claim 2, wherein the subject gas is a fugitive/stray gas.

9. A method comprising determining the thermal maturity of a subject gas sampled from a source location.

10. The method of claim 9, further comprising analyzing migration characteristics of the subject gas using noble gas geochemistry.

11. The method of claim 10, wherein analyzing migration characteristics includes evaluating temperature-dependent diffusional release of noble gases from quartz grains at the source location, chromatographic separation/solubility fractionation during fluid migration, and degree of water interaction with rock at the source location.

12. The method of claim 10, wherein analyzing migration characteristics includes determining a noble gas composition of the subject gas and comparing the noble gas composition with a corresponding noble gas composition of a reference gas sampled from the source location and applying a linear discriminant statistical analysis.

13. The method of claim 10, wherein analyzing migration characteristics further comprises determining a noble gas composition of the subject gas and comparing the noble gas composition with a corresponding noble gas composition of a reference gas sampled from the source location and applying statistical analysis.

14. The method of claim 10, wherein the subject gas is a hydrocarbon.

15. The method of claim 14, wherein the subject gas is a thermally-mature hydrocarbon.

16. The method of claim 10, wherein the subject gas is a fugitive/stray gas.
